(19) United States
(12) Patent Application Publication
(10) Pub. No.: US 2006/0189358 A1
(43) Pub. Date: Aug. 24, 2006

(54) Rechargeable dual-use transceiver set for audio applications

(75) Inventor: Johnson Hsu, Taoyuan Hsien (TW)

Correspondence Address: Johnson HSU, P.O. Box 90, Tainan City, 70499, TW

(73) Assignee: SUNPOWER UNIVERSAL TECHNOLOGY CORP.

(21) Appl. No.: 11/062,869

(22) Filed: Feb. 23, 2005

(51) Int. Cl. H04B 1/38

(52) U.S. Cl. 455/573

(57) ABSTRACT

A rechargeable dual-use transceiver set for audio applications comprises a first transceiver and a second transceiver. The first transceiver includes a device end USB connector; a first connecting end USB connector; and a first transceiver unit. The second transceiver includes a second connecting end USB connector; at least one I/O (input/output) port; a second transceiver unit; and a rechargeable battery. The I/O port may be at least one of an earphone or a speaker. Thereby a reel can be installed to the second transceiver for winding the wire of the I/O port. The transceiver set can be used to a wired device or a wireless device. Furthermore, the second transceiver is rechargeable without using any discrete or separate power supply.

### FIELD OF THE INVENTION

The present invention relates to wireless devices, and in particular to a rechargeable dual-use transceiver set for audio applications, wherein the transceiver set can be used as or to a wired device or a wireless device. Furthermore, the transceiver is rechargeable without using any power supply.

### BACKGROUND OF THE INVENTION

In the prior art wireless speaker and/or earphone must be matched with a wireless transceiver built in a device, such as a handset or a personal digital assistance (PDA), etc. so as to transmit signals therebetween. Thereby the wireless speaker and/or earphone is manufactured to match these devices, it cannot be used singly. However there are many devices which are not wireless. For example, generally, most of computers are not equipped with wireless transceivers. In fact, in the general design, the computer is used in wired environment. However this is not advantageous for many applications. Especially, currently, there are more and more usages which are integrated into computers, for example, Kara OK application. In the application of Kara, wireless is more convenient. However if the computer does not provide a wireless application, the singer will feel uneasy in use because he (or she) is confined in an area covered by the length from the speaker to the computer. Thereby there is an eager demand which can resolve above mentioned defect in the application.

### SUMMARY OF THE INVENTION

Accordingly, the primary object of the present invention is to provide a rechargeable dual-use transceiver set for audio applications, wherein the transceiver set can be used as or to a wired device or a wireless device. Furthermore, the transceiver is rechargeable without using any power supply.

To achieve above objects, the present invention provides a rechargeable dual-use transceiver set for audio applications which comprises a first transceiver and a second transceiver. The first transceiver includes a device end USB connector capable of being connected to a device for transferring signals into the first transceiver or out of the first transceiver; the first connecting end USB connector capable of being connected to another USB connector so that signals can be transmitted from or received into the first transceiver; The first transceiver unit being an RF device for wired or wireless transmission or receiving signals from the connecting end USB connector. The second transceiver includes a second connecting end USB connector capable of being connected to another USB connector so that signals can be transmitted from or received into the second transceiver. At least one I/O (input/output) port capable of being connected to the ear of the user so that signals can be transmitted to the ear of the user; the second transceiver unit being an RF device for wired or wireless transmission signals between the second connecting end USB connector and the I/O port; and a rechargeable battery for charging electric power from the first transceiver so as to be used for the second transceiver. Thereby the I/O port may be at least one of an earphone or a speaker. Moreover, a reel can be installed to the second transceiver for winding the wire of the I/O port.

The various objects and advantages of the present invention will be more readily understood from the following detailed description when read in conjunction with the appended drawing.

### BRIEF DESCRIPTION OF DRAWINGS

FIG. 1 is a block diagram showing the structure of the present invention.

FIG. 2 is a schematic view showing the first embodiment of the present invention.

FIG. 3 is a schematic view showing the second embodiment of the present invention.

FIG. 4 is a schematic view showing the third embodiment of the present invention.

FIG. 5 is a schematic view showing the fourth embodiment of the present invention.

### DETAILED DESCRIPTION OF THE PREFERRED EMBODIMENT

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

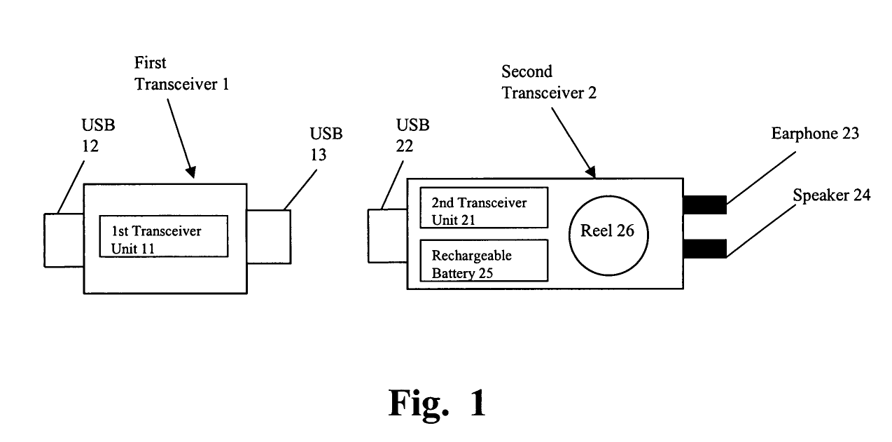

With reference to FIG. 1, the structure of the present invention is illustrated. The present invention has the following elements.

The first transceiver 1 includes the following elements. A device end USB connector 12 is capable of being connected to a device, such as a computer, a handset, a personal digital assistance (PDA), a MP3 player, for transferring signals into the first transceiver 1 or out of the first transceiver 1. The first connecting end USB connector 13 is capable of being connected to another USB connector so that signals can be transmitted from or received into the first transceiver 1. The first transceiver unit 11 is an RF device for wired or wireless transmission or receiving signals from the connecting end USB connector 13.

The second transceiver 2 has the following elements. The second connecting end USB connector 22 is capable of being connected to another USB connector so that signals can be transmitted from or received into the second transceiver 2. At least one earphone 23 is capable of being connected to the ear of the user so that signals can be transmitted the ear of the user. A speaker 24 serves for receiving signals from the user so as to transfer the signals to the second transceiver unit 21. The second transceiver unit 21 is an RF device for wired or wireless transmission signals between the second connecting end USB connector 22, at least one earphone 23, and the speaker 24. A rechargeable battery 25 serves for charging electric power from the first transceiver 1 so as to be used for the second transceiver 2 when both parts of the two transceivers are connected to each other by the USB physically. Furthermore, the second transceiver 2 can be further includes a reel 26 for winding the wires of at least one earphone 23 or the speaker 24.

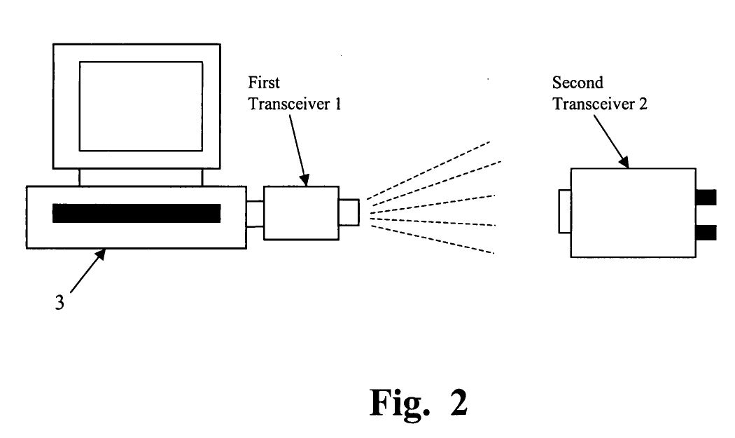

A first embodiment of the present invention will be described herein. The present invention can be used in two cases. In the first application, as shown in FIG. 2, the first transceiver 1 is connected to a device 3, in this example the device 3 is a computer. However general, the computer is not equipped with a wireless transmission means. Thus by the first transceiver 1 of the present invention, the signals are transmitted between the computer 3 and the first transceiver 1. Then the user can wear the second transceiver 2 to receive the signals from the first transceiver 1 or transmit the signals to the first transceiver 1. Thereby the user can hear sound from the computer by the earphone or transmit sounds to the computer 3 through the speak 24.

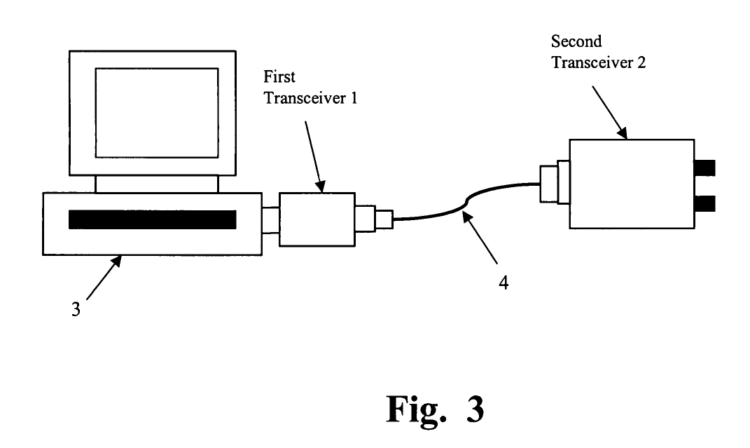

The second embodiment of the present invention is illustrated in FIG. 3, wherein those same as the first embodiment will not be further described herein. The difference of this embodiment from the first one is that an USB connecting wire 4 is used to connect the first transceiver 1 and the second transceiver 2 so that the signals can be transferred between the user and the computer 3 by the wired way. Thereby in this operation mode, the power can be charged to the rechargeable battery 25. Furthermore, it is appreciated that if the present invention is used only for charging power to the second transceiver 2, the second transceiver 2 can be directly connected to the first transceiver 1 without using the USB connecting wire 4. However from this embodiment, it is shown that the present invention can be charged without using any discrete or separate power supply.

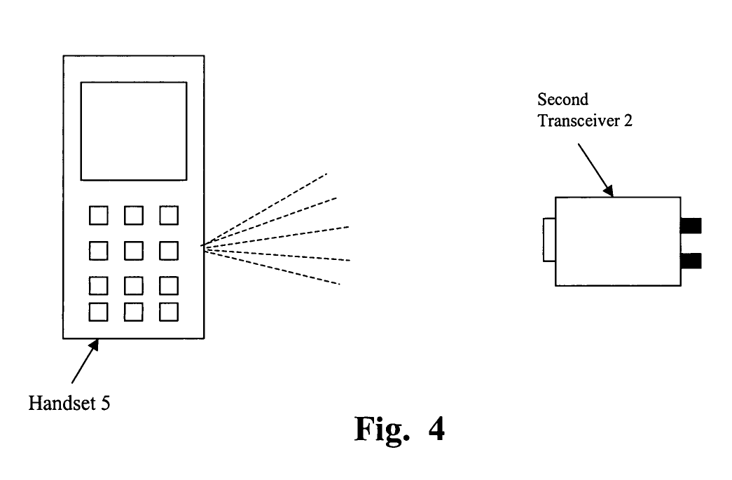

Referring to FIG. 4, the third embodiment of the present invention is illustrated, wherein the present invention is applied to a device, for example a handset 5 or a PDA, which is original equipped with wireless transceiver compatible to the second transceiver 2 of the present invention. Thereby in this embodiment, the second transceiver 2 can be used directly with the handset 5 without needing the first transceiver 1. In such a case or a similar one, the battery of the second transceiver can be charged directly from the USB on the PDA or other devices.

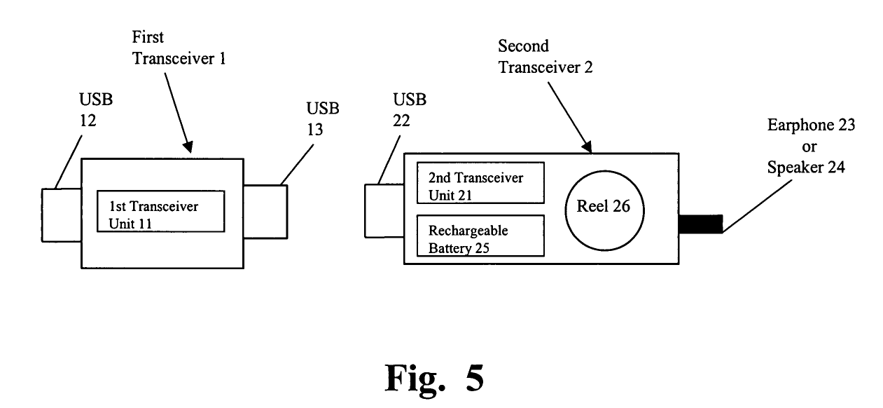

Referring to FIG. 5, a fourth embodiment of the present invention is illustrated, where it is illustrated that in second transceiver 2 of the present invention, there is only one port is left, that is the second transceiver 2 may be only one earphone 24 or only one speaker 25. However all these are within the scope of the present invention and thus confined by the present invention.

The present invention is thus described, It will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A rechargeable dual-use transceiver set for audio applications comprising:
a first transceiver including:
a device end USB connector capable of being connected to a device for transferring signals into the first transceiver or out of the first transceiver;
a first connecting end USB connector capable of being connected to another USB connector so that signals can be transmitted from or received into the first transceiver;
a first transceiver unit being an RF device for wired or wireless transmission or receiving signals from the connecting end USB connector; and,
a second transceiver including:
a second connecting end USB connector capable of being connected to another USB connector so that signals can be transmitted from or received into the second transceiver;
at least one I/O (input/output) port capable of being connected to the ear of the user so that signals can be transmitted into the ear of the user or sound is transferred into the second transceiver;
a second transceiver unit being an RF device for wired or wireless transmission signals between the second connecting end USB connector and the I/O port; and,
a rechargeable battery for charging electric power from the first transceiver to be used for the second transceiver.

2. The rechargeable dual-use transceiver set for audio applications as claimed in claim 1, wherein the second transceiver further includes a reel for winding the wires of at least one I/O port.

3. The rechargeable dual-use transceiver set for audio applications as claimed in claim 1, wherein the I/O port is at least one of an earphone and a speaker.

4. The multifunctional transceiver set for audio applications as claimed in claim 1, wherein the first transceiver is coupled to the second transceiver by a wired way or a wireless way.

5. The multifunctional transceiver set for audio applications as claimed in claim 1, wherein the first transceiver is coupled to the second transceiver by a connecting wire and the rechargeable battery is charged from the first transceiver directly without using any power supply.
